(19) United States
(12) Patent Application Publication
(10) Pub. No.: US 2025/0272312 A1
(43) Pub. Date: Aug. 28, 2025

(54) CLUSTERING EXECUTION MANAGEMENT IN A DATABASE SYSTEM

(71) Applicant: Snowflake Inc., Bozeman, MT (US)

(72) Inventors: Varun Ganesh, San Bruno, CA (US); Prasanna Kumar Krishnamurthy, Sunnyvale, CA (US); Wen Yuen Pang, Waterloo (CA)

(21) Appl. No.: 18/586,797

(22) Filed: Feb. 26, 2024

(51) Int. Cl. G06F 16/28; G06F 16/23

(52) U.S. Cl. CPC G06F 16/285; G06F 16/2343; G06F 16/2379

(57) ABSTRACT

A method includes retrieving, by at least one hardware processor in a database system, a database table. The database table includes a plurality of partitions. A plurality of batches is generated for the database table based on a file selection task of the database system. Each batch of the plurality of batches includes a partition subset of the plurality of partitions. A plurality of execution jobs is configured based on an execution management task of the database system. Each execution job of the plurality of execution jobs includes a batch subset of the plurality of batches, and the skew of batch sizes for the batch subset is below a threshold skew. Concurrent execution of the plurality of execution jobs is performed to cluster the partition subset associated with each of the plurality of execution jobs.

### TECHNICAL FIELD

Embodiments of the disclosure relate generally to databases and, more specifically, to clustering execution management in a database system.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used for storing different types of content, such as bibliographic, full text, numeric, and/or image content. Further, in computing, different database systems may be classified according to the organizational approach of the database. There are many different types of databases, including relational databases, distributed databases, cloud databases, object-oriented databases, and others.

The database configuration can include organizing data in database tables. However, existing database table organization and maintenance techniques can result in increased processing times, inefficient use of computing resources, and increased costs to users.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a diagram illustrating the components of a compute service manager using a clustering execution manager (CEM), in accordance with some embodiments of the present disclosure.

FIG. 3 is a diagram illustrating components of an execution platform, in accordance with some embodiments of the present disclosure.

FIG. 4 is a diagram illustrating the logical structure of a database table, in accordance with some embodiments of the present disclosure.

FIG. 5 is a diagram illustrating the physical structure of the database table of FIG. 4 in memory, in accordance with some embodiments of the present disclosure.

FIG. 6 is a diagram illustrating a simplified view of how partition overlap affects the clustering ratio for a table, in accordance with some embodiments of the present disclosure.

FIG. 7 is a diagram of database table partitions before and after clustering configured by the CEM of FIG. 2, in accordance with some embodiments of the present disclosure.

FIG. 8 is a diagram illustrating the transformation of database table partitions during clustering, in accordance with some embodiments of the present disclosure.

FIG. 9 is a diagram illustrating an execution model for clustering database table partitions, in accordance with some embodiments of the present disclosure.

FIG. 10 is a diagram illustrating the selection of batches for execution jobs performed by the execution model of FIG. 9, in accordance with some embodiments of the present disclosure.

FIG. 11 is a diagram illustrating the idle times of execution nodes performing the execution jobs of the execution model of FIG. 9, in accordance with some embodiments of the present disclosure.

FIG. 12 is a diagram illustrating another execution model for clustering database table partitions configured by the CEM of FIG. 2, in accordance with some embodiments of the present disclosure.

FIG. 13 is a diagram illustrating the execution jobs configuration by the execution model of FIG. 9 and the execution model of FIG. 12, in accordance with some embodiments of the present disclosure.

FIG. 14 is a diagram illustrating the concurrent execution of jobs by the execution model of FIG. 9 and the execution model of FIG. 12, in accordance with some embodiments of the present disclosure.

FIG. 15 is a diagram of a transactional queue with completed clustering jobs configured to activate a DML lock prior to committing clustered data to a database table, in accordance with some embodiments of the present disclosure.

FIG. 16 is a diagram of the transactional queue of FIG. 15, including a clustering-specific commit lock ahead of the DML lock, in accordance with some embodiments of the present disclosure.

FIG. 17 is a flow diagram illustrating the operations of a database system in performing a method for configuring clustering execution jobs using a CEM, in accordance with some embodiments of the present disclosure.

FIG. 18 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

A database table (also referred to as a table) can be defined as a collection of records (or rows). Each record contains a collection of values of table attributes (or columns). Tables can be physically stored in multiple smaller (varying size or fixed size) storage units, e.g., files or blocks. These files or blocks may be part of different partitions of the table. The term “partitioning” can be defined as physically separating records with different data to separate data partitions. For example, a table can partition data based on the date attribute (or column), resulting in “per day” partitions, or based on the country attribute (or column), resulting in a “per country” partition.

In some aspects, database systems can use partitioning to split large tables into manageable chunks of data. The ability to eliminate partitions (or partition pruning) can be based on predicates specified by the query, may result in a dramatic reduction of the input/output (IO) volume, and can be essential to maintain the acceptable performance of those systems.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below. In some aspects, the terms “micro-partition” and “partition” are used herein interchangeably.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, eXtensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

In some aspects, a database table can be partitioned as manually specified by a database administrator. For example, the administrator may provide the number of partitions and/or the partitioning keys. However, in order to manually specify these details, the administrator needs to have a good understanding of the query workload to select the correct partitioning keys. Also, the number of partitioning keys is typically limited as it directly translates into a fragmentation of the physical storage. Additionally, maintaining partitions is typically very expensive in terms of computation power and time.

A related concept to partitioning is clustering or ordering. Ordering (using a set of ordering key attributes or columns) orders the data (e.g., in a database table) according to the values of these key attributes. Clustering may be defined as physically grouping records (or rows) (e.g., in partitions) that have values that are close together. For example, rows sharing the same keys may be put next to each other (or in the same partition). Ordering according to a set of keys is one approach to achieve clustering based on those keys. The values sharing the same key may be next to each other, but the groups sharing the same key or close keys do not need to be adjacent. In some aspects, the term “ordering” can be used where the terms or concepts of “clustering” or “partial ordering” could also be applied. These concepts differ from partitioning as they do not introduce separate physical entities (e.g., it is possible to order data for the entire table or within a part of the table).

Reclustering of a database table is a process that reorganizes the physical layout of data in the table to improve query performance (e.g., read a partition from a table, sort the partition, and write the partition back to a table). In some aspects, reclustering can be made available as a Data Manipulation Language (DML) statement that a user account can invoke manually. A database system may provide specific functions for computing metrics exposing how well clustered a table is and may further provide a current recommended practice for the client account to manually invoke such function to determine when and how much of a database table should be reclustered. A user account may follow this practice of manually reclustering one or more database tables and achieve satisfactory clustering overall, but this requires significant diligence and attention from the user account. Manual reclustering of a database table can require considerable tuning and may be time-consuming to implement. To keep up with ongoing DML operations, users may need to run reclustering from time to time. The effectiveness of manual reclustering is often limited by resources such as the size of a virtual warehouse configured to perform the clustering operation. Additionally, manually reclustering operations may block client DML operations such as delete, update, and merge operations.

In some aspects, clustering (or reclustering) of table data (e.g., data in database table partitions) results in delayed processing due to data skew (e.g., difference in partition sizes of partitions in a processing batch of an execution job). The disclosed techniques include using a clustering execution manager (CEM) that provides a solution to scaling execution and handling skew in grouping batches of work that cluster data in a table and reduce the impact of that skew such that the overall cost of a clustering service is lowered. Existing clustering techniques do not use breakdown or grouping of data based on skew. Existing clustering techniques will sort the batches by size and still group them into a single job, which results in processing delays and inefficiencies. As used herein, the term “clustering depth” indicates the degree to which partitions overlap with each other.

In some aspects, the disclosed techniques use clustering execution that is configured by the CEM in terms of batches. As used herein, the term “batch” indicates a set of partitions of a table (e.g., micro-partitions) with overlaps that can be sorted and re-written independently (e.g., on a single machine or execution node). In some aspects, the disclosed techniques can be used to scale clustering execution in two ways—by the number of jobs executing a batch, and by running on a larger compute warehouse (also referred to as a virtual warehouse) and by running more batches concurrently (e.g., one batch on each execution node in the compute warehouse).

Skew occurs when an execution job (e.g., a clustering execution job) has batches that vary in size and are run in the same job. By independently identifying that a skew exists in the group of batches being executed, the disclosed techniques can be used to isolate that batch into a separate execution unit and continue to operate on batches that are similar in size to achieve higher throughput. This results in an efficient execution where all execution nodes are optimally utilized.

The disclosed techniques can configure the CEM to use an iterative execution model (e.g., where processing cycles through a set of batches at a time and then another set following that), which allows for generating a pipeline of work following clustering file selection (the process of deciding which set of partitions to group into batches and the number of batches to generate based on the current state of the table). The CEM can configure the file selection to be performed initially and clustering execution management to be performed iteratively after all batches of a table are stored in a queue, which is more efficient than having to run multiple file selections to achieve the same effect.

The disclosed clustering configuration techniques (e.g., as performed by the disclosed CEM) allow for iterative progress on the table clustering, thereby allowing users visible pruning improvement by the clustering state being incrementally improved. Additional advantages of the disclosed clustering configuration techniques include providing flexible and isolatable skew management. Using the disclosed techniques, file selection can happen independently of the execution jobs that perform clustering of the batches. In some aspects, the execution jobs can be configured by considering the maximum number of jobs that can lock the table.

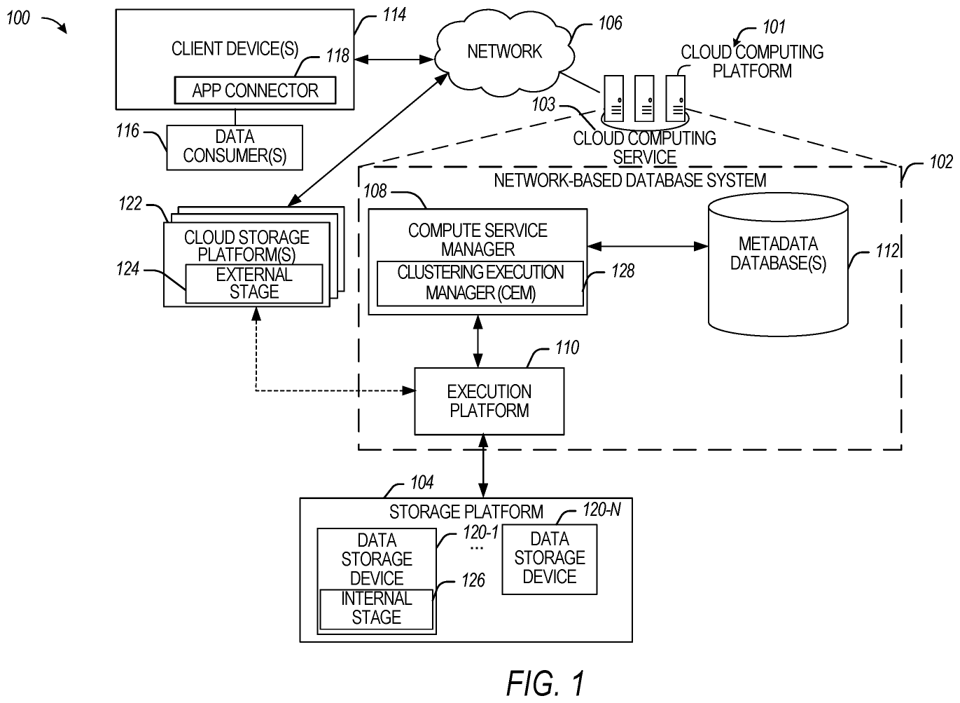

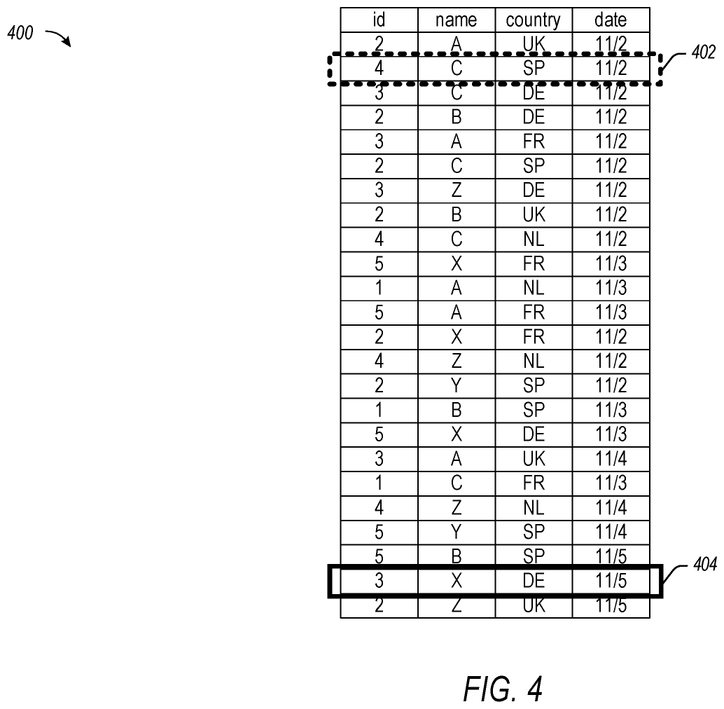

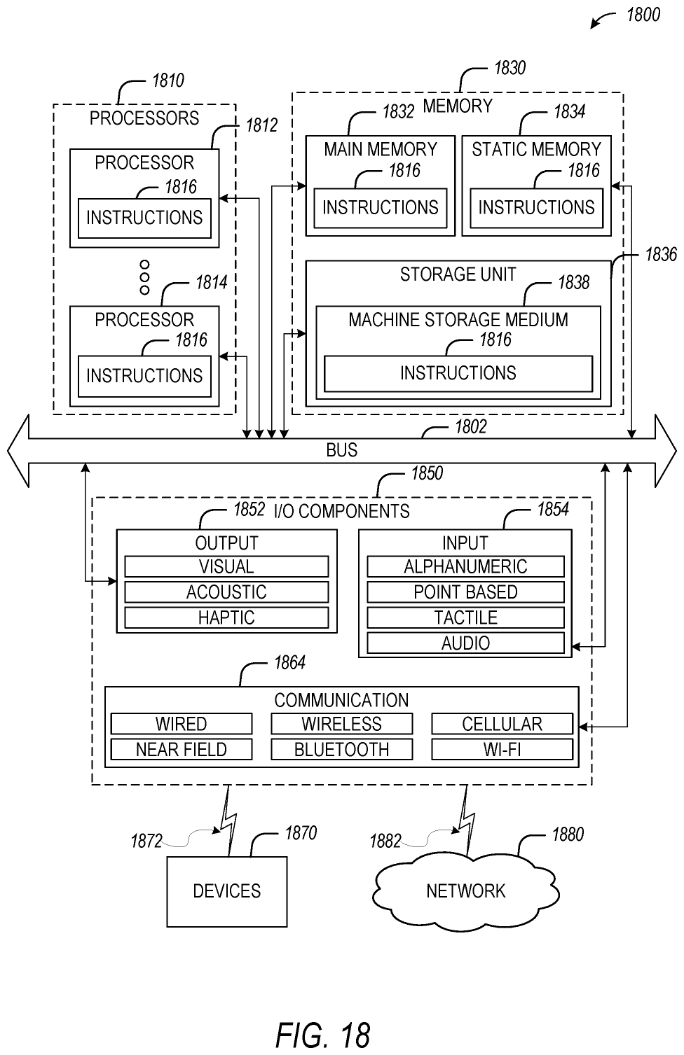

The various embodiments that are described herein are described with reference, where appropriate, to one or more of the various figures. An example computing environment using a CEM is discussed in connection with FIGS. 1-3. Example configuration and functions associated with the CEM are discussed in connection with FIGS. 4-17. A more detailed discussion of example computing devices that may be used in connection with the disclosed techniques is provided in connection with FIG. 18.

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not explicitly described herein. In other embodiments, the computing environment may comprise another type of network-based database system or a cloud data platform. For example, in some aspects, the computing environment 100 may include a cloud computing platform 101 with the network-based database system 102 and storage platforms 104 and 122. The cloud computing platform 101 provides computing resources and storage resources that may be acquired (purchased) or leased (e.g., by users such as data providers and data consumers) and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the attribute store configuration functions described herein). The cloud computing platform 101 may include a three-tier architecture: data storage (e.g., storage platforms 104 and 122), an execution platform 110, and a compute service manager 108 providing clustering configuration and management services (e.g., functionalities of the clustering execution manager (CEM) 128 to configure and manage clustering using the disclosed techniques).

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform, which is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the storage platforms 104 and 122 (e.g., AWS®, Microsoft Azure Blob Storage®, or Google Cloud Storage), client device 114 (e.g., a data provider), and data consumer 116 via network 106. The network-based database system 102 is a network-based system used for reporting and analysis of integrated data from one or more disparate sources, including one or more storage locations within the storage platform 104. The storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services (as well as additional services such as the disclosed task queue management functions) to multiple client accounts, including an account of the data provider associated with client device 114 and an account of the data consumer 116. In some embodiments, the compute service manager 108 comprises the CEM 128, which can be used in connection with configuring clustering execution in the network-based database system 102. A more detailed description of the functions provided by the CEM 128 is provided in connection with FIGS. 4-17.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts, such as end-users providing data storage and retrieval requests, accounts of data providers, accounts of data consumers, system administrators managing the systems and methods described herein, and other components/devices that interact with the compute service manager 108.

The compute service manager 108 is also communicating with a client device 114. The client device 114 corresponds to a user of one of the multiple client accounts (e.g., a data provider or another type of user) supported by the network-based database system 102. The data provider may utilize application connector 118 at the client device 114 to submit data storage, retrieval, and analysis requests to the compute service manager 108 as well as to access or configure other services provided by the compute service manager 108 (e.g., services associated with the disclosed clustering-related functions).

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client devices (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some aspects, a data consumer 116 can communicate with the client device 114 to access functions offered by the data provider. Additionally, the data consumer can access functions (e.g., clustering-related functions) offered by the network-based database system 102 via network 106.

The compute service manager 108 is also coupled to one or more metadata databases 112 that store metadata about various functions and aspects associated with the network-based database system 102 and its users. For example, a metadata database of the one or more metadata databases 112 may include a summary of data stored in remote data storage systems as well as data available from a local cache. Additionally, a metadata database of the one or more metadata databases 112 may include information regarding how data is organized in remote data storage systems (e.g., the storage platform 104) and the local caches. Information stored by a metadata database of the one or more metadata databases 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to storage platforms 104 and 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data storage technology. Additionally, the storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the storage platforms 122.

In some embodiments, communication links between elements of the computing environment 100 are implemented via one or more data communication networks, such as network 106. The one or more data communication networks may utilize any communication protocol and any communication medium. In some embodiments, the data communication networks are a combination of two or more data communication networks (or sub-networks) coupled with one another. In alternate embodiments, these communication links are implemented using any communication medium and any communication protocol.

The compute service manager 108, the one or more metadata databases 112, the execution platform 110, and the storage platform 104 are shown in FIG. 1 as individual discrete components. However, each of the compute service manager 108, one or more metadata databases 112, execution platform 110, and storage platforms 104 and 122 may be implemented as a distributed system (e.g., distributed across multiple systems/platforms at multiple geographic locations). Additionally, each of the compute service manager 108, one or more metadata databases 112, execution platform 110, and storage platforms 104 and 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database of the one or more metadata databases 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the storage platform 104. It is desirable to retrieve as much data as possible from caches within the execution platform 110 because the retrieval speed is typically much faster than retrieving data from the storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the storage platform 104. Thus, the computing resources and cache resources are not restricted to specific data storage devices 120-1 to 120-N. Instead, all computing resources and all cache resources may retrieve data from and store data to any of the data storage resources in the storage platform 104.

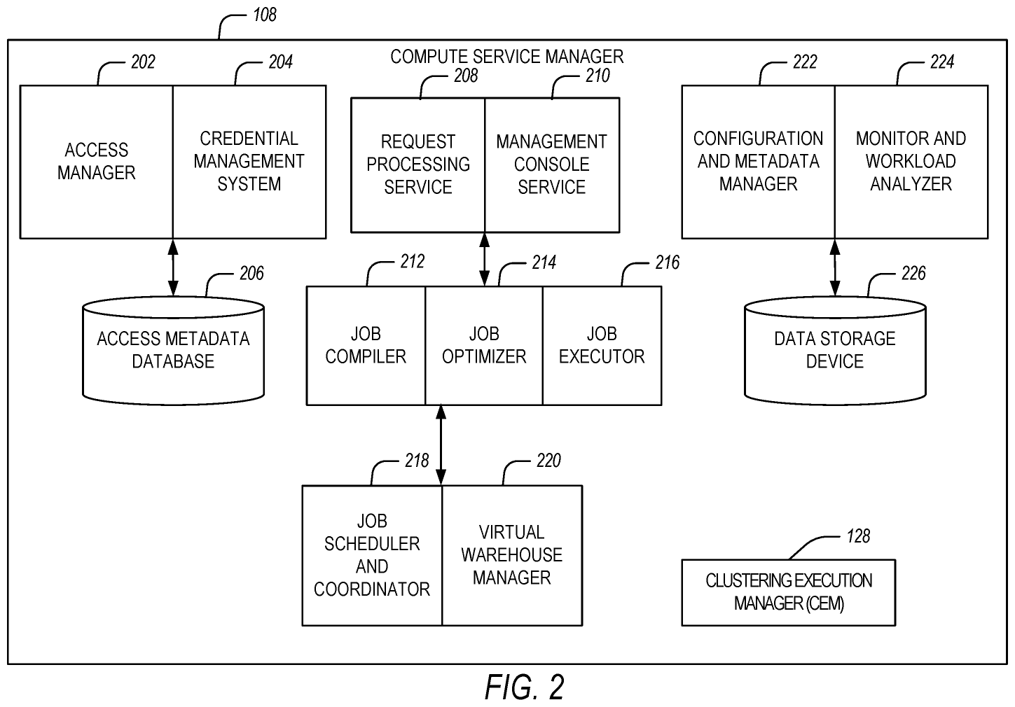

FIG. 2 is a diagram illustrating the components of the compute service manager 108 using a clustering execution manager (CEM), in accordance with some embodiments of the present disclosure. As shown in FIG. 2, the compute service manager 108 includes an access manager 202 and a credential management system 204 coupled to an access metadata database 206, which is an example of the one or more metadata databases 112. Access manager 202 handles authentication and authorization tasks for the systems described herein. The credential management system 204 facilitates the use of remotely stored credentials to access external resources, such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in the execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2) and should be disallowed from communicating with a third execution node (e.g., execution node 312-1) and any such illicit communication can be recorded (e.g., in a log or other location). Also, the information stored on a given execution node is restricted to data relevant to the current query, and any other data is unusable, rendered so by destruction or encryption where the key is unavailable.

In some embodiments, the compute service manager 108 further includes the CEM 128, which can be used in connection with configuring and managing clustering in the network-based database system 102.

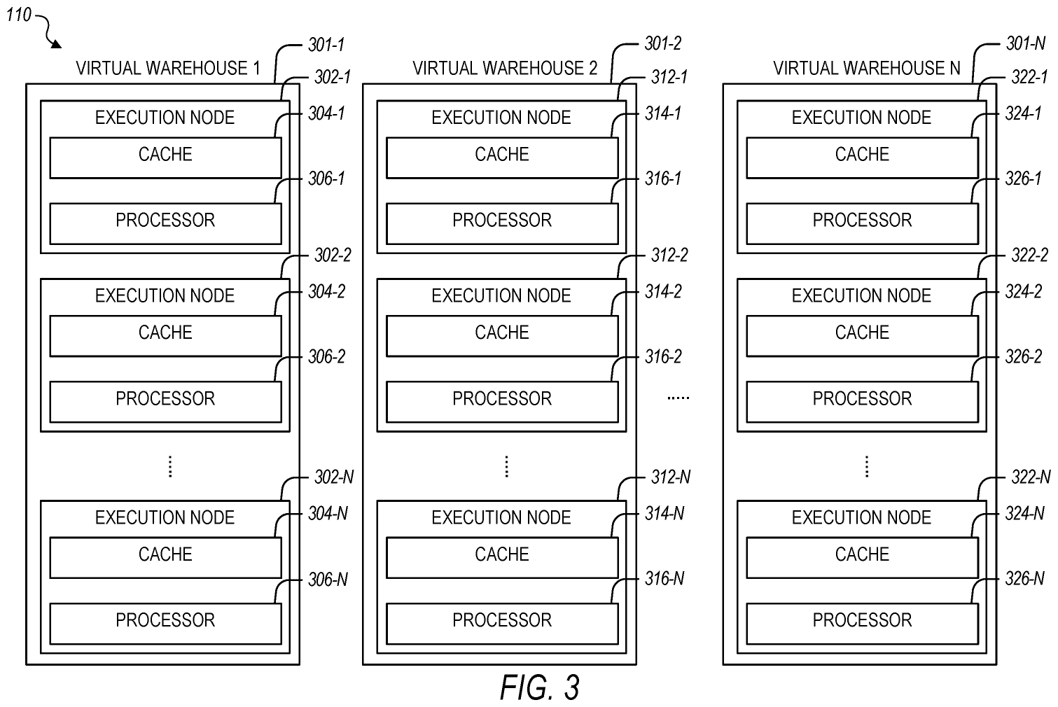

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, they can access data from any of the data storage devices 120-1 to 120-N within the storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes: 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes: 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes: 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless concerning the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while another computing system implements virtual warehouses 2 and n at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the storage platform 104, but each virtual warehouse has its execution nodes with independent processing and caching resources. This configuration allows requests on different virtual warehouses to be processed independently and with no interference between the requests. This independent processing, combined with the ability to add and remove virtual warehouses dynamically, supports the addition of new processing capacity for new users without impacting the performance observed by the existing users.

In some embodiments, the clustering-related functionalities performed by the CEM 128 can be configured based on the following configurations discussed in connection with FIGS. 4-17.

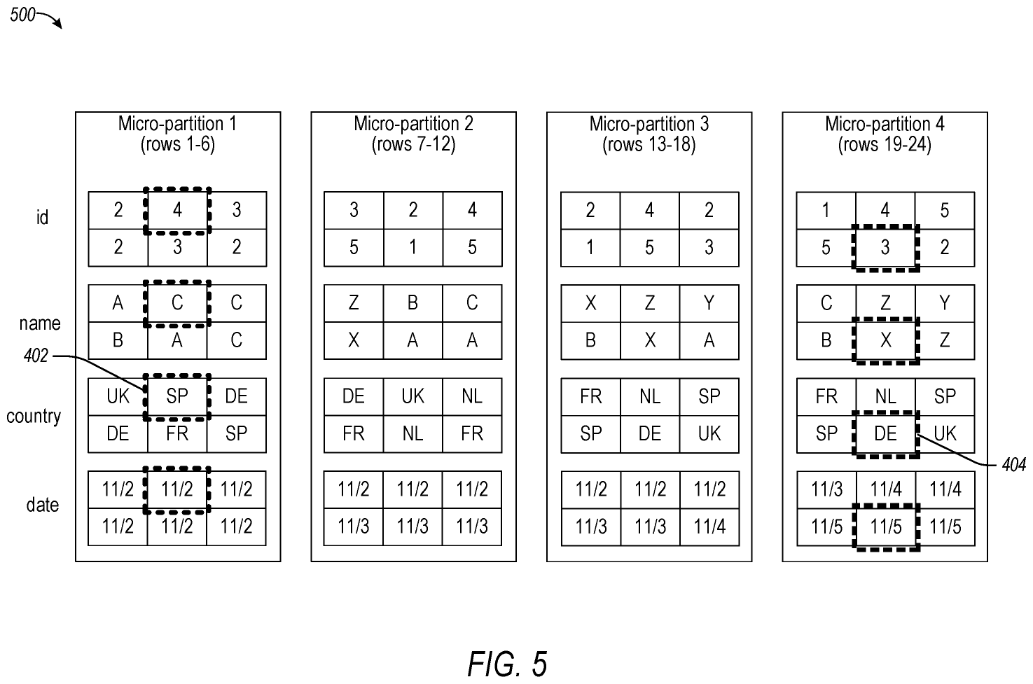

FIG. 4 is a diagram illustrating the logical structure of a database table 400, and FIG. 5 is a diagram illustrating the physical structure 500 of the database table of FIG. 4 in memory, in accordance with some embodiments of the present disclosure.

Table 400 has 4 columns naturally sorted (e.g., as received/added) and 24 rows. The data of Table 400 is stored across 4 micro-partitions, shown in the physical structure 500 (in FIG. 5), with the rows divided equally between each micro-partition. Row 2 is shown with bolded dash line 402, and row 23 is shown with bolded solid line 404 in both the logical structure shown in FIG. 4 and the physical structure 500 shown in FIG. 5 to illustrate how they relate.

Within each micro-partition, the data is sorted and stored by the date column, which enables the system to perform the following actions for queries on the table: prune micro-partitions that are not needed for the query and prune by column within the remaining micro-partitions. Even though partitions are sorted by column, the partitions are not necessarily sorted relative to each other, and there is some overlap between partitions (e.g., micro-partitions 1, 2, and 3 all include an 11/2 date).

The configuration and metadata manager 222 maintains clustering metadata for the micro-partitions in a table. The metadata may include one or more of the total number of micro-partitions for a table, the number of micro-partitions containing values that overlap with each other (in a specified subset of table columns), and/or the depth of the overlapping micro-partitions. In one embodiment, these details may be accessed using the following system functions: SYSTEM$CLUSTERING_DEPTH, SYSTEM$CLUSTERING_INFORMATION, and SYSTEM$CLUSTERING_RATIO.

The clustering ratio may be computed based on overlaps of partitions with each other, the average number of partitions that overlap for each value in a column, or other parameters. In one embodiment, the clustering ratio for a table is a number between 0 and 100, which indicates whether the clustering state of the table has improved or deteriorated due to changes to the data in the table. The higher the ratio, the more optimally clustered the table is, with a value of 100 indicating that the table is fully clustered. Clustering ratios can be used for a variety of purposes, including monitoring the clustering “health” of a large table, particularly over time as DML is performed on the table, and/or determining whether a large table would benefit from explicitly defined clustering keys.

The clustering ratio for a table may not be an absolute or precise measure of whether the table is well-clustered. It may be a relative value intended as a guideline for optimizing data storage within a specific table. Clustering ratios may not be helpful as comparisons between tables because every table and data clustering scenario is different depending on the data characteristics of the table. In other words, if a table has a higher ratio than another table, it does not necessarily indicate that the first table is better clustered than the second table. Ultimately, query performance is often the best indicator of how well-clustered a table is. If queries on a table are performing as needed or expected, the table is likely well-clustered, and subsequent reclustering may not dramatically change the ratio or improve performance. Suppose query performance degrades over time, and there is a corresponding lowering in the clustering ratio for the table. In that case, the table is likely no longer optimally clustered and would benefit from reclustering (e.g., using the disclosed techniques that can be performed by CEM 128).

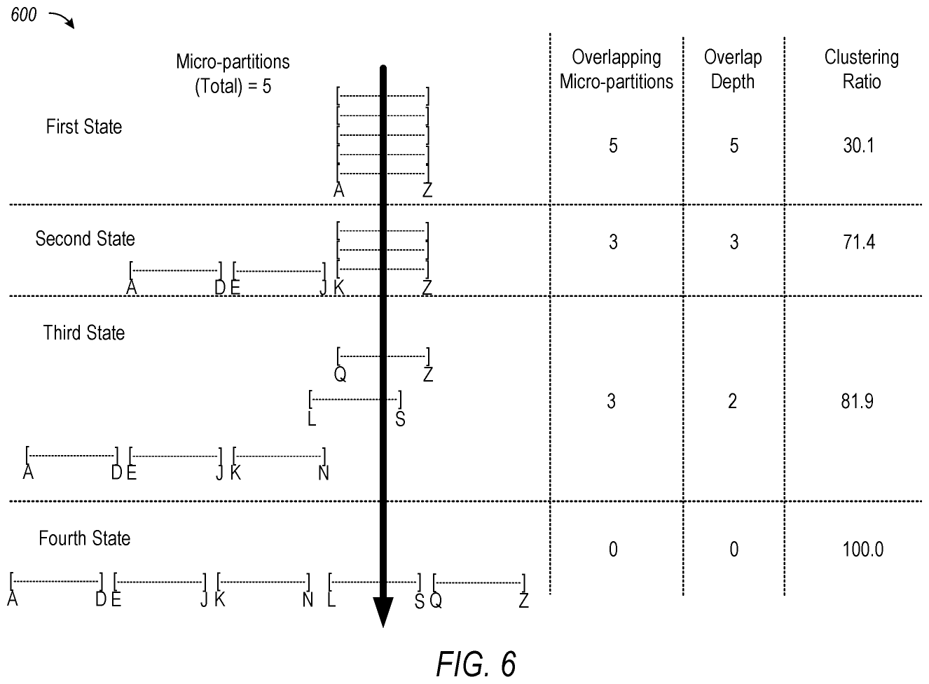

FIG. 6 is diagram 600 illustrating a simplified view of how partition overlap affects the clustering ratio for a table, in accordance with some embodiments of the present disclosure. Overlap for a table consisting of 5 micro-partitions is illustrated in FIG. 6, at various stages with corresponding statistics for the number of overlapping micro-partitions, overlap depth, and clustering ratio. The table is clustered on a column comprising values ranging from A to Z. In the first state, the range of values in all the micro-partitions overlap, and the clustering ratio is low (e.g., 30.1). As the number of overlapping micro-partitions decreases and the overlap depth decreases in the second and third states, the clustering ratio improves (e.g., 71.4 and 81.9, respectively). When there is no overlap in the range of values across all micro-partitions, the micro-partitions are considered to be in a constant state (i.e., they cannot be improved by reclustering), and the table has a clustering ratio of 100. In this fourth state, the table is considered to be fully clustered.

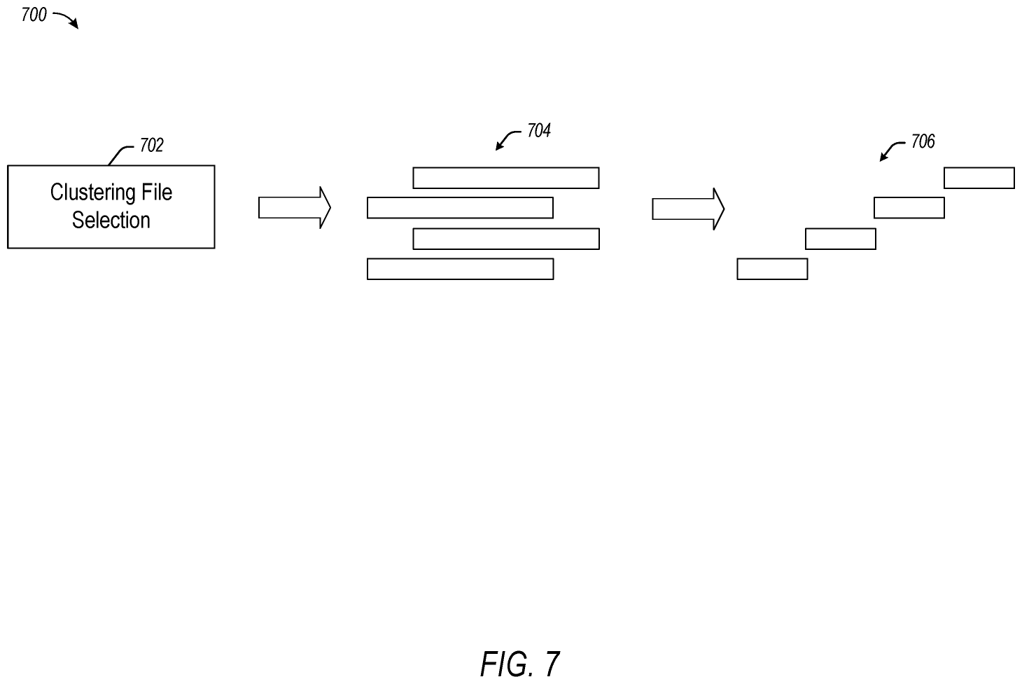

FIG. 7 is a diagram 700 of database table partitions before and after clustering configured by the CEM of FIG. 2, in accordance with some embodiments of the present disclosure. Referring to FIG. 7, CEM 128 can perform clustering file selection 702, which can include selecting batches of partitions (e.g., partitions associated with a table) for clustering. For example, CEM 128 can perform the clustering file selection 702 in connection with disclosed clustering functions to select batch 704. As illustrated in FIG. 7, batch 704 includes four overlapping partitions, which are to be scanned, sorted, and re-inserted in the table. For example, after clustering, the partitions in batch 704 are transformed into non-overlapping partitions 706, which can be re-inserted back into the source table.

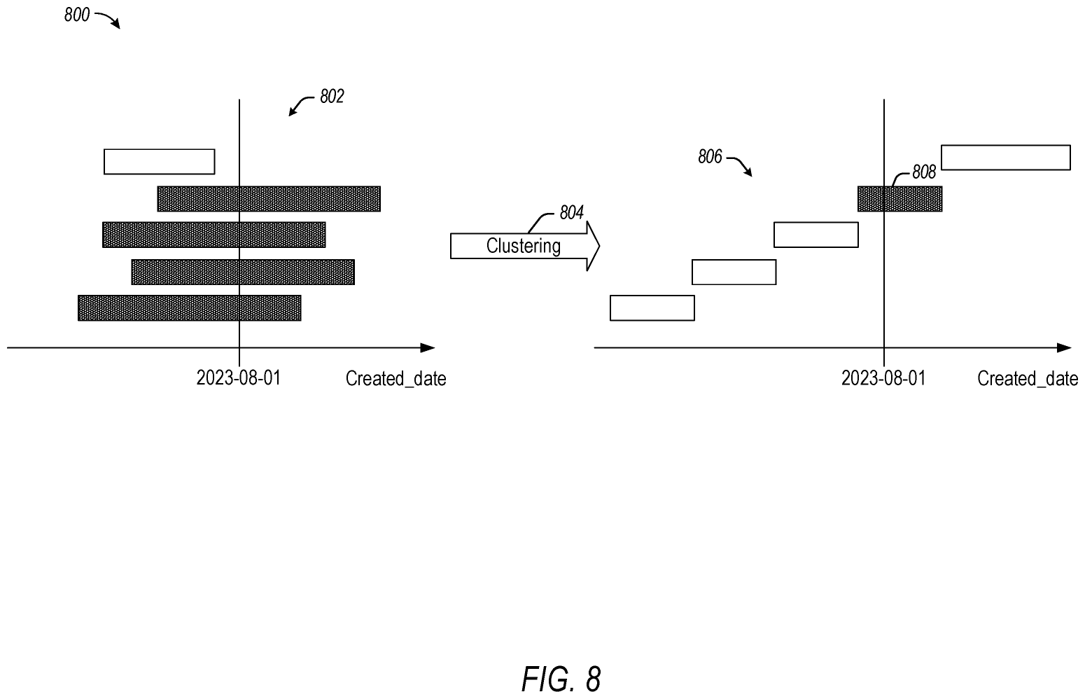

Generating non-overlapping partitions by CEM 128 can be beneficial as it results in more efficient query processing (e.g., as illustrated in FIG. 8).

FIG. 8 is a diagram 800 illustrating the transformation of database table partitions during clustering, in accordance with some embodiments of the present disclosure. Referring to FIG. 8, the network-based database system 102 can receive the following query for processing using batch 802: select * from logs where created_date=‘2023-08-01’. As illustrated in FIG. 8, batch 802 includes multiple overlapping partitions associated with an overlapping date range that includes the queried date of 2023-08-01. CEM 128 can perform clustering 804 (e.g., using the disclosed techniques) to generate clustered partitions 806. After clustering is completed and clustered partitions 806 are re-inserted back into the source table, the query can be processed more efficiently using a single partition 808 that includes the queried date.

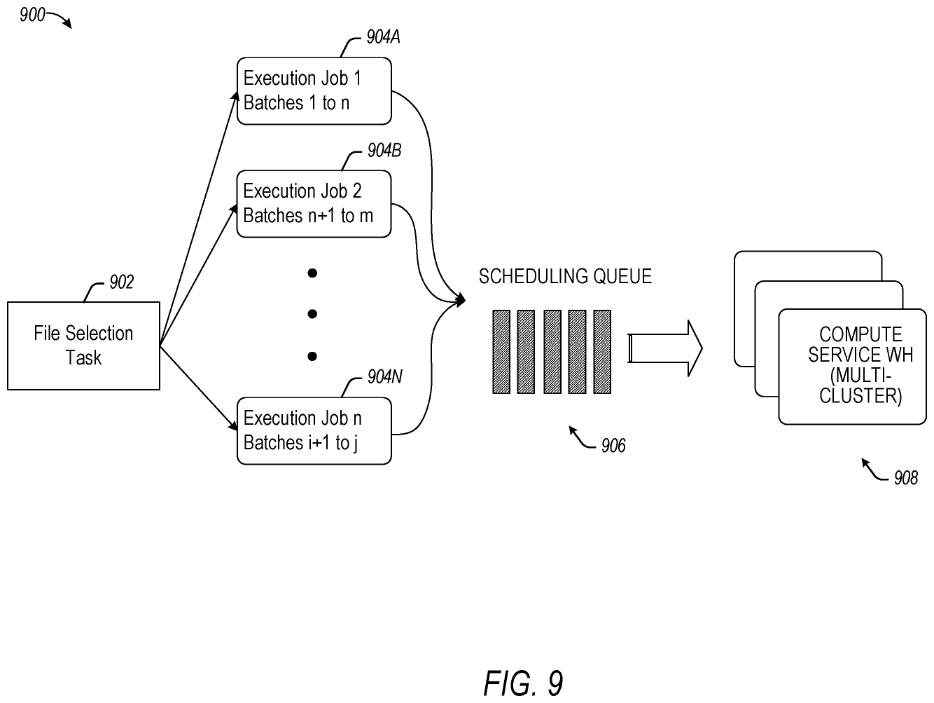

FIG. 9 is a diagram illustrating an execution model 900 for clustering database table partitions, in accordance with some embodiments of the present disclosure. Referring to FIG. 9, execution model 900 can be performed by CEM 128 and can include performing a file selection task 902. The file selection task 902 can include retrieving a clustering key (e.g., from a user of a database table), retrieving the partitions of the table, determining overlap between the partitions, determining which partitions should be reclustered (e.g., based on the clustering key), and generating execution jobs 904A, 904B, . . . , 904N with each execution job including multiple batches that can be reclustered.

The execution jobs 904A, . . . , 904N can use scheduling queue 906 to add batches for reclustering using computing resources of multi-cluster compute service warehouse 908. In some aspects, multi-cluster compute service warehouse 908 can include computing resources (e.g., execution nodes) of the execution platform 110.

In some aspects, clustering performed by the CEM 128 scales out by means of batches, with each batch being an isolated set of files that can be sorted by a single core in a single machine of the multi-cluster compute service warehouse 908.

In some aspects, the file selection task 902 can determine the maximum number of batches in an execution job and the number of jobs as follows:

(a) The maximum number of batches in an execution jobs can be Max batch size=Min(maxLockWaiters*serverTarget, maxBatchsetSize), where MaxLockWaiters=20, serverTarget is the number of servers in one cluster of a compute service warehouse (e.g., serverTarget=16 for an extra large (XL) warehouse), and maxBatchsetSize under standard policy is 128 and under extreme is 1024. Therefore, Max Batch Size=Min(20*16, 128/1024), which is either 128 or 320 batches in a job as the maximum cap for an XL warehouse. For a 2XL compute warehouse, this can go up to 640 batches. In some aspects, a single batch can have up to 32*16 MB bytes of micro-partitions. In some aspects, the size of each of the micro-partitions is configurable. In some aspects, the maximum number of lock waiters (MaxLockWaiters) is configurable and can be other than 20.

(b) the maximum number of execution jobs can be determined based on numJobs=ceil(numBatches/numServerslnComputeServiceWh), where numBatches is the total number of batches for a table and numServersInComputeServiceWh is the number of servers in the multi-cluster compute service warehouse 908.

In some aspects, MaxLockWaiters (which is the maximum number of completed transactions that can place a lock prior to being committed) can control the number of waiters on the table version. In some aspects, the number of execution jobs can be limited to MaxLockWaiters (e.g., 20) to minimize the pressure on the DML lock queue.

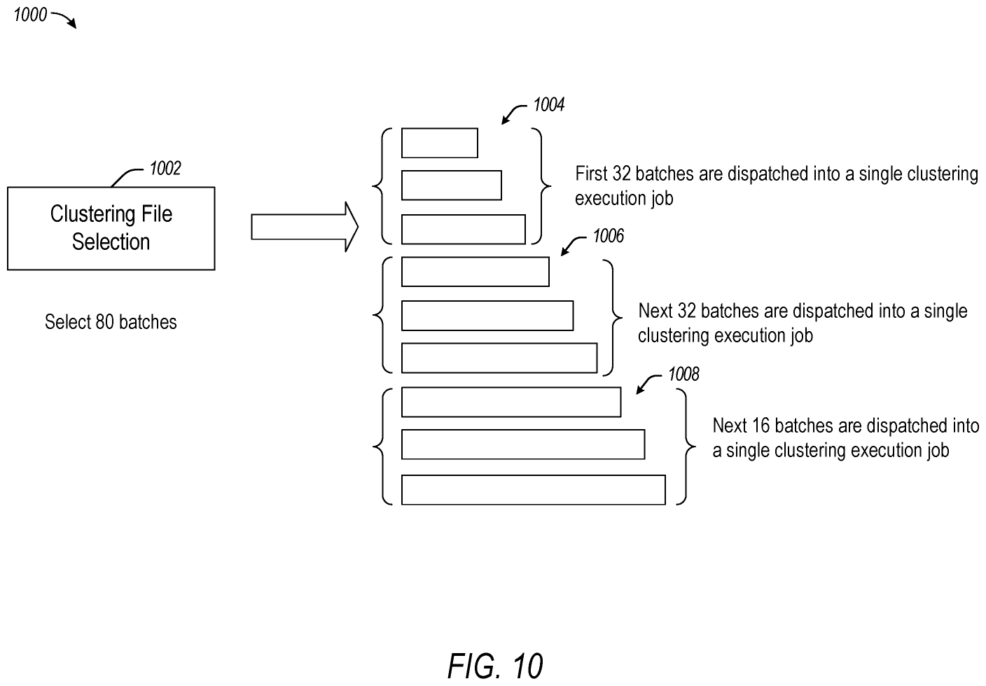

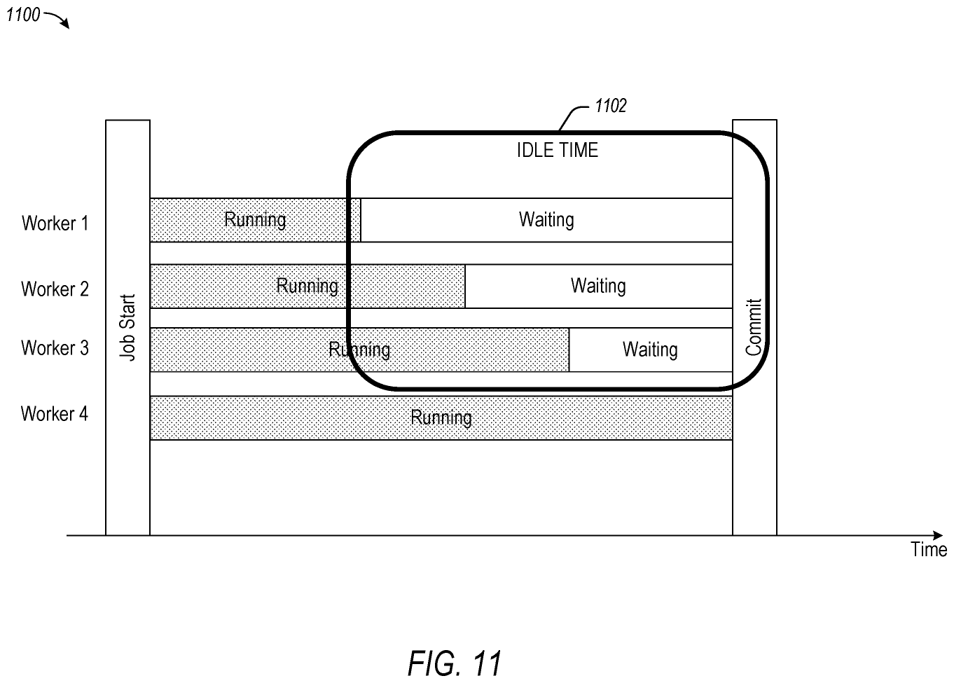

In some aspects, execution model 900 is associated with the following drawbacks:
(a) There is a limit (e.g., MaxLockWaiters) on the number of execution jobs that can concurrently lock on a table and have a right to commit (each job being independent of the other jobs and can wait in a queue for committing).
(b) The number of batches per job and the number of total jobs can be increased to make the clustering service run faster. However, in some aspects, a skewed distribution results in straggling batches holding up the entire job from committing faster (e.g., as illustrated in FIG. 10 and FIG. 11), and the other batches that finish sooner result in workers being idle for the entire period. Thus, increasing batches per job by using more workers results in the following inefficiencies:
(b.1) Clustering costs are higher due to the larger number of idle workers.
(b.2) Longer running skews result in a greater window of allowing for conflicting mutations on the table, resulting in erroneous results (the larger the number of batches per job, the larger the erroneous results). The erroneous results cause inefficiencies as such results are discarded.
(b.3) Slower progress results in a longer time where incremental clustering effect is not present, providing windows for slower queries.

FIG. 10 is a diagram 1000 illustrating the selection of batches for execution jobs performed by the execution model of FIG. 9, in accordance with some embodiments of the present disclosure. Referring to FIG. 10, the CEM 128 can determine (or select) a set of batches during the clustering file selection 1002. For example, 80 batches can be determined and sorted according to size.

The CEM 128 can dispatch the first 32 batches 1004 into a single clustering execution job. The following 32 batches 1006 are dispatched into a second clustering execution job, and the remaining 16 batches 1008 are dispatched into a third clustering execution job.

FIG. 11 is a diagram 1100 illustrating the idle times of execution nodes performing the execution jobs of the execution model of FIG. 9, in accordance with some embodiments of the present disclosure. Referring to FIG. 11, different workers of the multi-cluster compute service warehouse 908 can perform clustering on a set of batches (e.g., batches 1004, 1006, or 1008) that are of different sizes. As illustrated in FIG. 11, the clustering during the execution job results in a significant idle time 1102.

In some aspects, incremental clustering progress can be more piecemeal to avoid job-batch dependency issues. On one extreme, clustering can be configured with a swarm of 1 batch job after file selection. However, this may result in stress on the transaction lock queue (especially when processing 1024 batches on a table is desired). This may also induce stress on the compute warehouse and the compute service task queue. A more significant number of tasks will result in increased dequeue latency of those tasks.

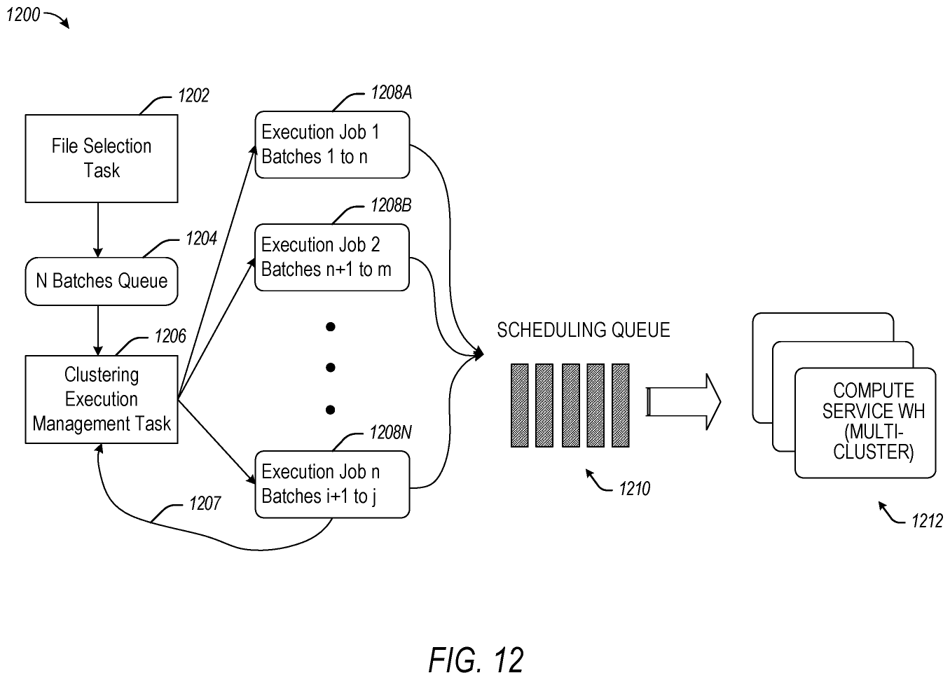

As an alternative, the execution model 1200 of FIG. 12 introduces a layer of indirection by having a separate execution management task whose role is to make piecemeal progress on the N batches generated by the file selection job. In some embodiments, CEM 128 can be configured to perform clustering using the execution model of FIG. 12 to reduce the idle time and increase the clustering efficiency when executing multiple execution jobs with batches of a source table.

FIG. 12 is a diagram illustrating another execution model 1200 for clustering database table partitions configured by the CEM of FIG. 2, in accordance with some embodiments of the present disclosure. Referring to FIG. 12, execution model 1200 can be performed by CEM 128 and can include performing a file selection task 1202, which can also be referred to as a clustering file selection task. The file selection task 1202 can include retrieving a clustering key (e.g., from a user of a database table), retrieving the partitions of the table, determining overlap between the partitions, determining which partitions should be reclustered (e.g., based on the clustering key), and generating a set of batches for the database table. The generated set of batches can be stored in a batch queue 1204.

The execution model 1200 further includes a clustering execution management task 1206 configured to generate execution jobs 1208A, 1208B, . . . 1208N, with each execution job including multiple batches that can be reclustered. The execution jobs 1208A, . . . , 1208N can also be referred to as execution manager jobs.

In some embodiments, the clustering execution management task 1206 takes into account the row count of each batch when grouping them into individual execution jobs. For example, the clustering execution management task 1206 can include a batch in an execution job if the number of rows in the batch does not exceed the highest row count for an existing batch in the execution job by a first threshold. In some aspects, the clustering execution management task 1206 can add additional batches to an execution job so long as the total number of batches in the execution job is below a second threshold or the total number of rows in all batches in the execution job is below a third threshold.

The execution jobs 1208A, . . . , 1208N can use scheduling queue 1210 to add batches for reclustering using computing resources of multi-cluster compute service warehouse 1212. In some aspects, multi-cluster compute service warehouse 1212 can include computing resources (e.g., execution nodes) of the execution platform 110.

In some aspects, the number of batches in an execution job can be configured based on the number of machines in a compute cluster of the multi-cluster compute service warehouse 1212.

In some aspects, CEM 128 uses a separate clustering execution management task 1206 rather than configuring the file selection task 1202 to perform all functions (as in the execution model 900) to separate responsibilities and avoid having to iterate through file selection in smaller chunks. In some aspects, the clustering execution management task 1206 can group batches by their compression ratio size (e.g., ordering batches in ascending order of the compression ratio totalRawBytes/totalCompressedBytes) and group them in the execution jobs so that skew is better managed (e.g., to minimize skew among batches within an execution job).

In some aspects, skew can be identified by the number of rows in a batch, as the cost of sorting rows is linear within each table for most use cases. There may be no generic correlation between time to sort rows across multiple tables. Thus, if a skew is detected based on row count, it can be isolated regardless of bytes.

In some aspects, the execution model 1200 is configured to perform the following clustering-related functions as described above:
(a) The file selection task 1202 will trigger the clustering execution management task 1206 and a batch queue 1204 of N batches.
(b) The clustering execution management task 1206 groups together a portion of the generated batches from the previous step and triggers multiple execution jobs 1208A, . . . , 1208N (e.g., 20 jobs) at a time.
(c) Each execution job will run a successor check 1207 to see whether a pre-configured (threshold) number of execution jobs (e.g., at least 50% of jobs) have been completed. In some aspects, CEM 128 can configure this function based on a shared counter or by referencing the scheduling queue, If the threshold number of execution jobs has been completed, an execution management task is triggered again, which will repeat the above step (b) until all batches in the batch queue 1204 are processed (clustered).
(d) If all batches from the batch queue 1204 are drained, a separate condition can be triggered, which will then allow the execution jobs to raise the next file selection task as a successor.

In some aspects, if there is a pending set of batches following the first set of execution jobs, another execution manager job may get scheduled to organize the pending batches from file selection into more execution jobs. If there are no more pending batches, the file selection job can be scheduled as a follow-up to the execution manager job.

In some aspects, CEM 128 can configure a smaller number of batches in an execution job (e.g., smaller than a pre-configured threshold) with the expectation of these jobs finishing quickly. Completing the execution jobs quickly makes the turnaround time for progress on the queue of batches fast, given that there is not another file selection that happens in between batch processing in a job and that the execution jobs are pipelined and not serialized in terms of execution. The overall turnaround time may become slightly longer, but the benefit of keeping failures smaller, overall cost lower, and making incremental improvements to the table continuously rather than larger stepwise improvements may outweigh/override this additional time.

In some aspects, CEM 128 can use an additional configuration for using smaller batches based on the compression ratio skew in the batches. For example, suppose the difference in the ratio of total raw bytes and total compressed bytes (e.g., totalRawBytes/totalCompressedBytes) exceeds a threshold. In that case, a smaller number of batches (e.g., below a certain threshold) can be used to configure an execution job. If not, CEM 128 can continue configuring a larger number of batches (e.g., above a certain threshold) per execution job with the expectation that these jobs will be completed faster. This decision can be made by the clustering execution management task 1206.

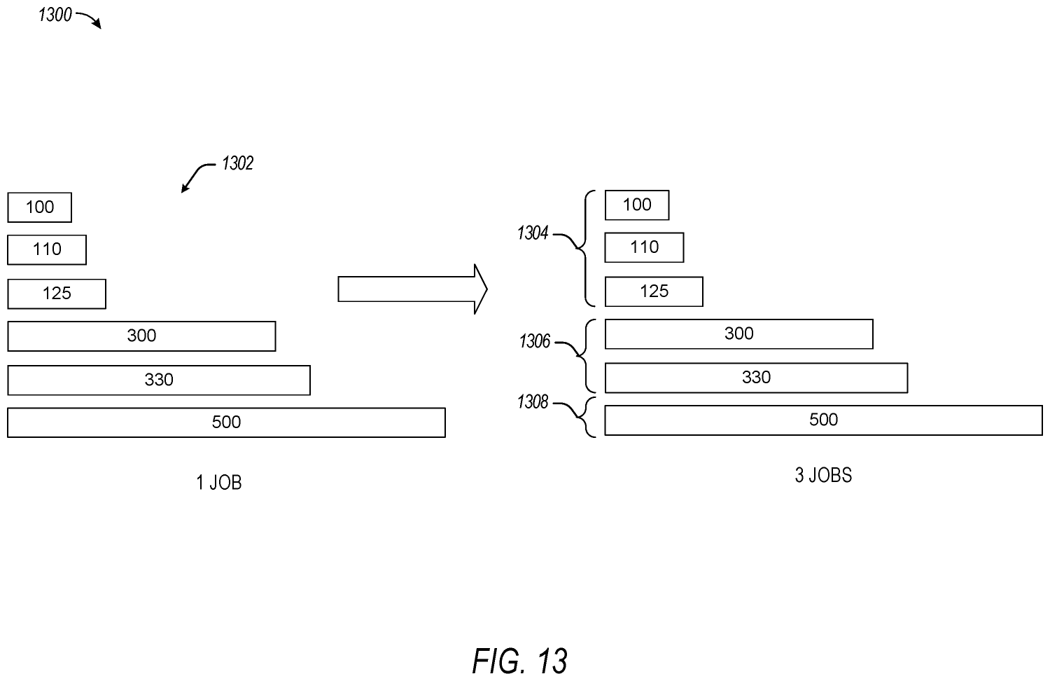

FIG. 13 is a diagram 1300 illustrating the execution jobs configuration by the execution model of FIG. 9 and the execution model of FIG. 12, in accordance with some embodiments of the present disclosure. Referring to FIG. 13, execution model 900 does not consider row count or skew between batches, which results in the file selection task configuring a single execution job 1302 with batches of significant variance in size (which would result in idle time and inefficient batch processing).

In comparison, execution model 1200 separates the same batches into three execution jobs (e.g., execution jobs 1304, 1306, and 1308). As illustrated in FIG. 13, the batches in execution jobs 1304-1308 are grouped based on batch size (or row count skew), which will result in a reduction (or elimination) of idle time during concurrent execution job processing.

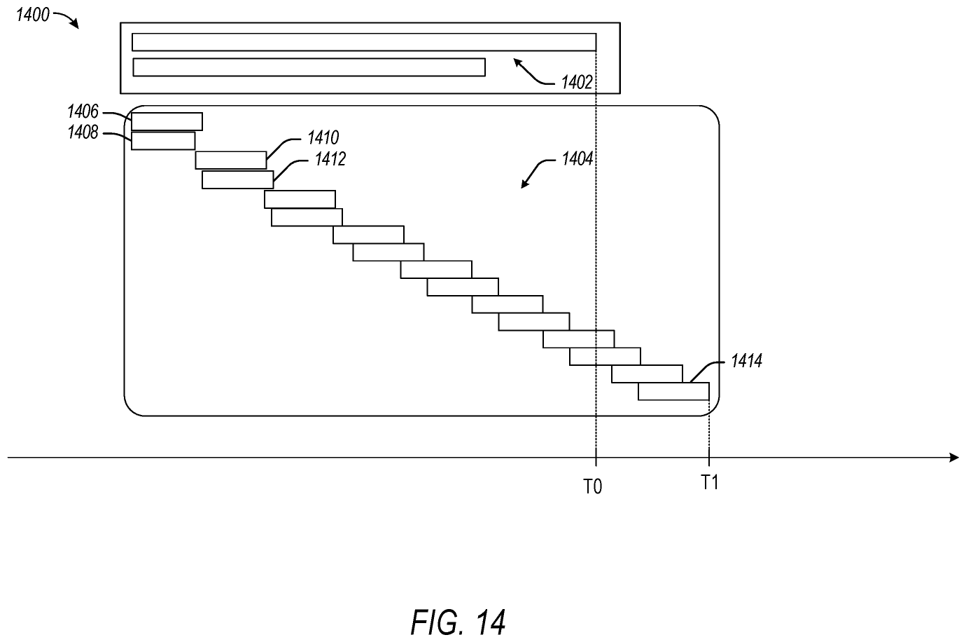

FIG. 14 is a diagram 1400 illustrating the concurrent execution of jobs by the execution model of FIG. 9 and the execution model of FIG. 12, in accordance with some embodiments of the present disclosure. Referring to FIG. 14, diagram 1400 shows an example comparison of execution model 900 with execution model 1200 in terms of the time taken to do the same work. More specifically, execution model 900 configures execution jobs 1402, and execution model 1200 configures execution jobs 1404. As illustrated in FIG. 14, execution jobs 1402 execute more batches (e.g., approximately 8 times more batches) per job than execution jobs 1404.

FIG. 14 further illustrates the effect of performing the successor check 1207. More specifically, execution jobs 1406 and 1408 execute concurrently. After job 1408 finishes, a new execution job 1410 starts. After execution job 1406 finishes, a new execution job 1412 starts, and so on, until the last execution job 1414 completes at time T1.

As illustrated in FIG. 14, execution model 900 has greater throughput if clustering is divided into smaller batch jobs. This will be slightly alleviated by breaking up the progress of smaller batches and pipelining them, but the difference in completion times (T1−T0) will still be observable. The reason for this is the decrease in concurrency. The machine costs of execution jobs 1404 is better than that of execution jobs 1402.

In some embodiments, CEM 128 can use the following configurations related to compute warehouse size and utilization optimization using warehouse pooling when configuring clustering-related functions.

In some aspects, all clustering execution jobs can be made into smaller-sized jobs. This means that the need for larger-sized warehouses can be considered.

In some aspects, only jobs where skewed batches are detected can migrate over to using smaller-sized jobs. The reasons to use this configuration is to reduce the pressure on the number of jobs that are generated on the database system and to maintain higher throughput on some tables where there is no skew present.

In some aspects, CEM 128 can use pooled warehouses where execution jobs with a similar number of batches are scheduled on warehouses with that many machines. As a result, the network-based database system 102 can use several pools of warehouses of different sizes that manage clustering jobs.

In some aspects, the execution task model will not generate as many large sized jobs and will generate more smaller sized jobs. There are two ways to address this feature:
(a) Increase the maximum cluster size of the smaller warehouses to several times more. No other changes will have to be made, and eventually, the larger warehouses can be decommissioned after evaluating that smaller-sized jobs are sufficient.
(b) Annotate and group jobs by table and total number of expected batches following file selection. This will provide the maximum concurrency that can be expected for a given table following file selection, and this information can be used to choose the warehouse for the jobs to run on appropriately. Thus, a job with, e.g., 32 batches will be replaced by 8 jobs of 4 batches. The 8 jobs can be treated as a single 32-batch job and will all get scheduled on an extra-large (XL) warehouse pool.

In some embodiments, CEM 128 can use the following configurations related to grouping improvement for the management of batches and scale when configuring clustering-related functions.

The addition of the clustering execution management task can increase the number of clustering execution jobs, which can result in increased processing runtime and longer DML lock queue. In some aspects, executions with a large number of batches have less idle time than executions with a small number of batches. This is because in executions with a large number of batches, sorting and dividing already reduces skew significantly, as batches of similar sizes are grouped.

In some aspects, it may not be necessary to further divide large jobs that already have a low skew. As such, CEM 128 can use a batch division algorithm that attempts to achieve a similar reduction in idleness time with a lower increase in the number of jobs. For example, a “maximum skew” (e.g., approximately 150 MB raw file size) can be selected, which is the maximum difference between the size of the largest and smallest batch in a job. After sorting the batches in descending order of size, CEM 128 can repeatedly try to fit the greatest number of batches into a job such that the “maximum skew” condition is satisfied. This approach tries to make the number of batches close or equal to the number of servers in an available warehouse size in the warehouse pool, which will reduce idle time and increase throughput.

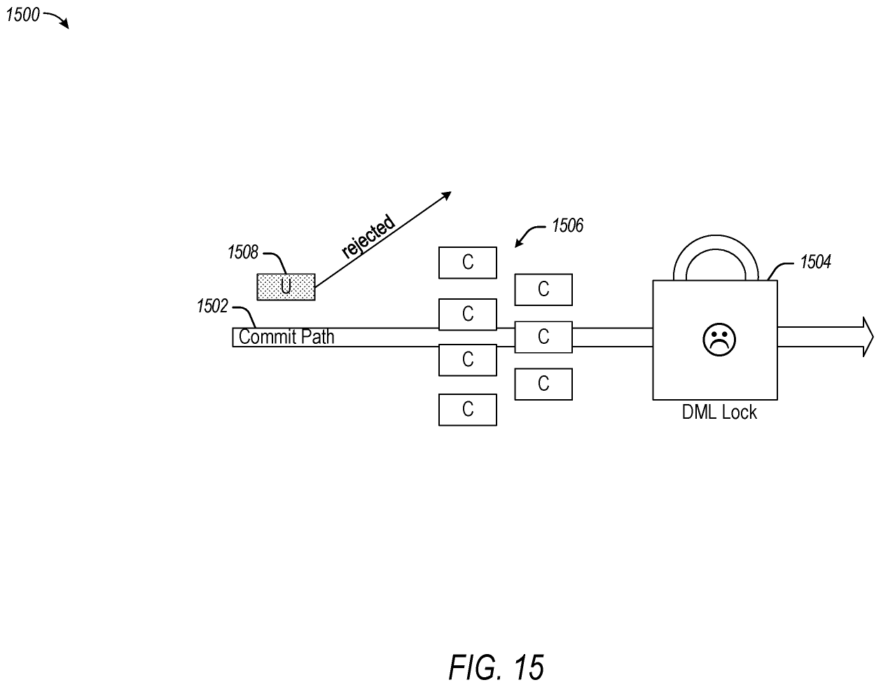

FIG. 15 is a diagram 1500 of a transactional queue with completed clustering jobs configured to activate a DML lock prior to committing clustered data to a database table, in accordance with some embodiments of the present disclosure. Referring to FIG. 15, the transactional queue 1502 (also referred to as a commit path) includes completed clustering execution jobs 1506, which can place a commit lock (e.g., DML lock 1504) on the source table. If a number of the completed clustering execution jobs 1506 is equal to the number of maximum DML locks that can be placed on a table, a user DML 1508 on the table can be rejected, which is undesirable.

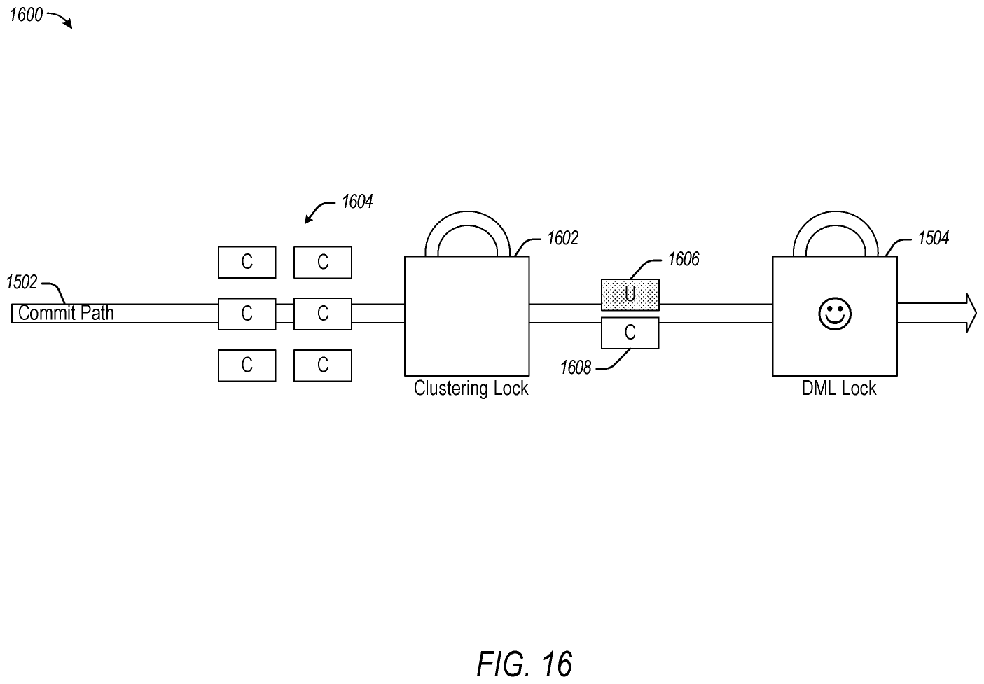

FIG. 16 is a diagram 1600 of the transactional queue of FIG. 15, including a clustering-specific commit lock ahead of the DML lock, in accordance with some embodiments of the present disclosure. Referring to FIG. 16, a clustering lock 1602 is configured ahead of the DML lock 1504 to prevent a user DML 1606 from being rejected from placing a DML lock 1504. In this regard, completed clustering execution jobs 1604 can place clustering lock 1602, which acts as a distributed semaphore for the completed clustering execution jobs 1604 to access the transactional queue and the DML lock 1504 for committing a transaction. In this regard, a limited number of completed clustering execution jobs (e.g., completed clustering execution job 1608) are allowed to place the DML lock 1504 so that a user DML 1606 is not rejected from also placing a DML lock on the table.

The concurrency number (e.g., 20 execution jobs) can be based on the maximum number of DML locks that can be placed on the table (e.g., maxNumLockWaiters). In some aspects, using this parameter as a limit on the number of concurrent execution jobs can be replaced by execution jobs taking an additional turnstile lock ahead of taking the table version lock (which is illustrated in FIG. 16). In this regard, committing can remain the same but a greater number of execution jobs can be run in parallel. If this restriction is removed, then a reasonable restriction in terms of a maximum number of jobs can be used for a maximum concurrency of a number of jobs.

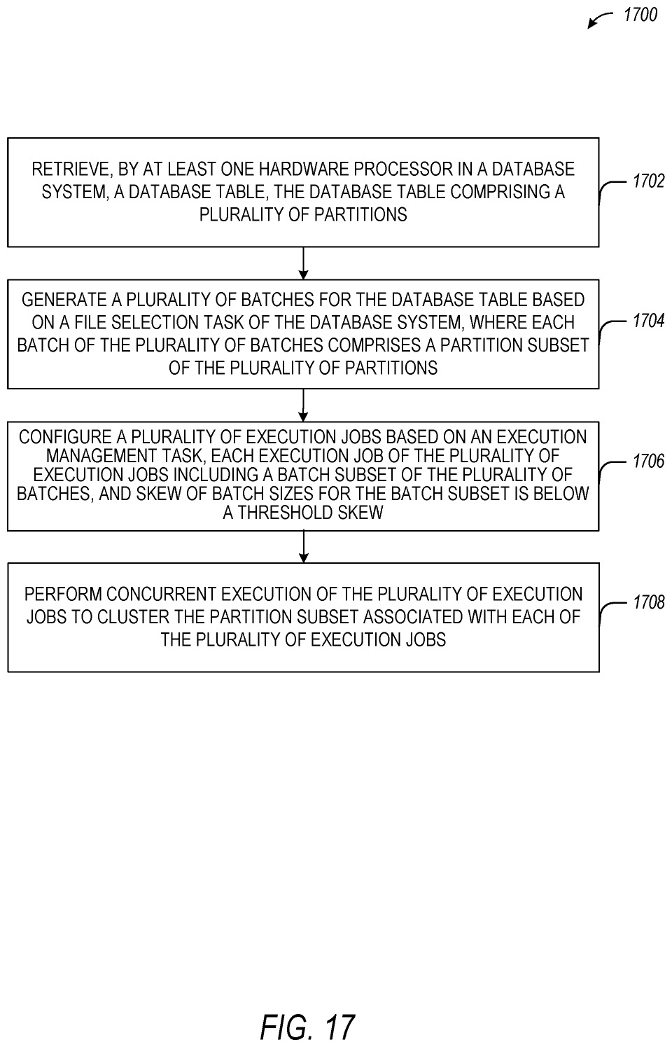

FIG. 17 is a flow diagram illustrating the operations of a database system in performing method 1700 for configuring clustering execution jobs using a CEM, in accordance with some embodiments of the present disclosure. Method 1700 may be embodied in computer-readable instructions for execution by one or more hardware components (e.g., one or more processors) such that the operations of method 1700 may be performed by components of network-based database system 102, such as components of the compute service manager 108 (e.g., the CEM 128) and/or the execution platform 110 (which components may be implemented as machine 1800 of FIG. 18). Accordingly, method 1700 is described below, by way of example with reference thereto. However, it shall be appreciated that method 1700 may be deployed on various other hardware configurations and is not intended to be limited to deployment within the network-based database system 102.

At operation 1702, a database table is retrieved by at least one hardware processor in a database system. For example, the file selection task 1202 of the CEM 128 retrieves a database table that includes a plurality of partitions.

At operation 1704, a plurality of batches for the database table is generated based on a file selection task of the database system. For example, file selection task 1202 generates a plurality of batches, which can be stored in batch queue 1204. Each batch of the plurality of batches includes a partition subset of the plurality of partitions.

At operation 1706, a plurality of execution jobs is configured based on an execution management task of the database system. For example, clustering execution management task 1206 of the CEM 128 configures execution jobs 1208A, . . . , 1208N. Each execution job of the plurality of execution jobs includes a batch subset of the plurality of batches. Additionally, clustering execution management task 1206 of the CEM 128 configures the execution jobs 1208A, . . . , 1208N so that the skew of batch sizes for the batch subset is below a threshold skew (e.g., skew can be determined based on row count for each batch in the execution job or based on one or more other configurations as discussed above).

At operation 1708, concurrent execution of the plurality of execution jobs is performed to cluster the partition subset associated with each of the plurality of execution jobs.

FIG. 18 illustrates a diagrammatic representation of machine 1800 in the form of a computer system within which a set of instructions may be executed for causing machine 1800 to perform any one or more of the methodologies discussed herein, according to an example embodiment. Specifically, FIG. 18 shows a diagrammatic representation of machine 1800 in the example form of a computer system, within which instructions 1816 (e.g., software, a program, an application, an applet, an app, or other executable code) for causing the machine 1800 to perform any one or more of the methodologies discussed herein may be executed. For example, instructions 1816 may cause machine 1800 to execute any one or more operations of method 1800 (or any other technique discussed herein, for example, in connection with FIG. 4-FIG. 17). As another example, instructions 1816 may cause machine 1800 to implement one or more portions of the functionalities discussed herein. In this way, instructions 1816 may transform a general, non-programmed machine into a particular machine 1800 (e.g., the compute service manager 108 or a node in the execution platform 110) that is specially configured to carry out any one of the described and illustrated functions in the manner described herein. In yet another embodiment, instructions 1816 may configure the compute service manager 108 and/or a node in the execution platform 110 to carry out any one of the described and illustrated functions in the manner described herein.

In alternative embodiments, machine 1800 operates as a standalone device or may be coupled (e.g., networked) to other machines. In a networked deployment, machine 1800 may operate in the capacity of a server machine or a client machine in a server-client network environment or as a peer machine in a peer-to-peer (or distributed) network environment. Machine 1800 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 1816, sequentially or otherwise, that specify actions to be taken by the machine 1800. Further, while only a single machine 1800 is illustrated, the term “machine” shall also be taken to include a collection of machines 1800 that individually or jointly execute the instructions 1816 to perform any one or more of the methodologies discussed herein.

Machine 1800 includes processors 1810, memory 1830, and input/output (I/O) components 1850 configured to communicate with each other such as via a bus 1802. In some example embodiments, the processors 1810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1812 and a processor 1814 that may execute the instructions 1816. The term “processor” is intended to include multi-core processors 1810 that may comprise two or more independent processors (sometimes referred to as “cores”) that may execute instructions 1816 contemporaneously. Although FIG. 18 shows multiple processors 1810, machine 1800 may include a single processor with a single core, a single processor with multiple cores (e.g., a multi-core processor), multiple processors with a single core, multiple processors with multiple cores, or any combination thereof.

The memory 1830 may include a main memory 1832, a static memory 1834, and a storage unit 1836, all accessible to the processors 1810, such as via the bus 1802. The main memory 1832, the static memory 1834, and the storage unit 1836 store the instructions 1816, embodying any one or more of the methodologies or functions described herein. The instructions 1816 may also reside, wholly or partially, within the main memory 1832, within the static memory 1834, within machine storage medium 1838 of the storage unit 1836, within at least one of the processors 1810 (e.g., within the processor's cache memory), or any suitable combination thereof, during execution thereof by the machine 1800.

The I/O components 1850 include components to receive input, provide output, produce output, transmit information, exchange information, capture measurements, and so on. The specific I/O components 1850 that are included in a particular machine 1800 will depend on the type of machine. For example, portable machines such as mobile phones will likely include a touch input device or other such input mechanisms, while a headless server machine will likely not include such a touch input device. It will be appreciated that the I/O components 1850 may include many other components that are not shown in FIG. 18. The I/O components 1850 are grouped according to functionality merely to simplify the following discussion, and the grouping is in no way limiting. In various example embodiments, the I/O components 1850 may include output components 1852 and input components 1854. The output components 1852 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 1854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 1850 may include communication components 1864 operable to couple the machine 1800 to a network 1880 or devices 1870 via a coupling 1882 and a coupling 1872, respectively. For example, communication components 1864 may include a network interface component or another suitable device to interface with network 1880. Further examples of communication components 1864 may include wired communication components, wireless communication components, cellular communication components, and other communication components to provide communication via other modalities. The device 1870 may be another machine or any of a wide variety of peripheral devices (e.g., a peripheral device coupled via a universal serial bus (USB)). For example, as noted above, machine 1800 may correspond to any one of the compute service manager 108 or the execution platform 110, and device 1870 may include the client device 114 or any other computing device described herein as being in communication with the network-based database system 102 or the storage platform 104.

The various memories (e.g., 1830, 1832, 1834, and/or memory of the processor(s) 1810 and/or the storage unit 1836) may store one or more sets of instructions 1816 and data structures (e.g., software) embodying or utilized by any one or more of the methodologies or functions described herein. These instructions 1816, when executed by the processor(s) 1810, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database and/or associated caches and servers) that store executable instructions and/or data. The terms shall accordingly be taken to include, but not be limited to, solid-state memories and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 1880 or a portion of network 1880 may include a wireless or cellular network, and coupling 1882 may be a Code Division Multiple Access (CDMA) connection, a Global System for Mobile Communications (GSM) connection, or another cellular or wireless coupling. In this example, the coupling 1882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1816 may be transmitted or received over network 1880 using a transmission medium via a network interface device (e.g., a network interface component included in the communication components 1864) and utilizing any one of several well-known transfer protocols (e.g., hypertext transfer protocol (HTTP)). Similarly, instructions 1816 may be transmitted or received using a transmission medium via coupling 1872 (e.g., a peer-to-peer coupling) to device 1870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1816 for execution by the machine 1800 and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments, the processors may be distributed across several locations.

Described implementations of the subject matter can include one or more features, alone or in combination, as illustrated below by way of examples.

Example 1 is a method comprising: retrieving, by at least one hardware processor in a database system, a database table, the database table comprising a plurality of partitions; generating a plurality of batches for the database table based on a file selection task of the database system, each batch of the plurality of batches comprising a partition subset of the plurality of partitions; configuring a plurality of execution jobs based on an execution management task of the database system, each execution job of the plurality of execution jobs including a batch subset of the plurality of batches, and skew of batch sizes for the batch subset is below a threshold skew; and performing concurrent execution of the plurality of execution jobs to cluster the partition subset associated with each of the plurality of execution jobs.

In Example 2, the subject matter of Example 1 includes generating a plurality of clustered partition subsets based on the completion of clustering of the partition subset for each of the plurality of execution jobs.

In Example 3, the subject matter of Example 2 includes activating a clustering lock on the plurality of clustered partition subsets, the clustering lock configured in a transactional queue for committing clustered data to the database table.

In Example 4, the subject matter of Example 3 includes activating the clustering lock based on a number of data manipulation language (DML) locks placed on the database table by transactions in the transactional queue.

In Example 5, the subject matter of Example 4 includes activating the clustering lock further based on a number of execution jobs in the plurality of execution jobs being higher than the maximum number of DML locks that can be placed on the database table.

In Example 6, the subject matter of Example 5 includes releasing the clustering lock when the number of DML locks is below a threshold number.

In Example 7, the subject matter of Examples 4-6 includes functionalities where at least one of the transactions in the transactional queue is a user DML query placing a DML lock of the DML locks on the database table.

In Example 8, the subject matter of Examples 1-7 includes selecting a number of execution jobs in the plurality of execution jobs based on a maximum number of data manipulation language (DML) locks that can be placed on the database table.

In Example 9, the subject matter of Examples 1-8 includes performing a successor check at the completion of each execution job of the plurality of execution jobs to determine the total number of completed execution jobs of the plurality of execution jobs.

In Example 10, the subject matter of Example 9 includes configuring at least one additional execution job based on the total number of completed execution jobs, the at least one additional execution job including a remaining subset of the plurality of batches.

Example 11 is a system comprising: at least one hardware processor; and at least one memory storing instructions that cause the at least one hardware processor to perform operations comprising: retrieving a database table of a database system, the database table comprising a plurality of partitions; generating a plurality of batches for the database table based on a file selection task of the database system, each batch of the plurality of batches comprising a partition subset of the plurality of partitions; configuring a plurality of execution jobs based on an execution management task of the database system, each execution job of the plurality of execution jobs including a batch subset of the plurality of batches, and skew of batch sizes for the batch subset is below a threshold skew; and performing concurrent execution of the plurality of execution jobs to cluster the partition subset associated with each of the plurality of execution jobs.

In Example 12, the subject matter of Example 11 includes the operations further comprising generating a plurality of clustered partition subsets based on the completion of clustering of the partition subset for each of the plurality of execution jobs.

In Example 13, the subject matter of Example 12 includes the operations further comprising activating a clustering lock on the plurality of clustered partition subsets and the clustering lock configured in a transactional queue for committing clustered data to the database table.

In Example 14, the subject matter of Example 13 includes the operations further comprising activating the clustering lock based on a number of data manipulation language (DML) locks placed on the database table by transactions in the transactional queue.

In Example 15, the subject matter of Example 14 includes the operations further comprising activating the clustering lock further based on a number of execution jobs in the plurality of execution jobs being higher than a maximum number of DML locks that can be placed on the database table.

In Example 16, the subject matter of Example 15 includes the operations further comprising releasing the clustering lock when the number of DML locks is below a threshold number.

In Example 17, the subject matter of Examples 14-16 includes functionalities where at least one of the transactions in the transactional queue is a user DML query placing a DML lock of the DML locks on the database table.

In Example 18, the subject matter of Examples 11-17 includes the operations further comprising selecting a number of execution jobs in the plurality of execution jobs based on a maximum number of data manipulation language (DML) locks that can be placed on the database table.

In Example 19, the subject matter of Examples 11-18 includes the operations further comprising performing a successor check at completion of each execution job of the plurality of execution jobs to determine a total number of completed execution jobs of the plurality of execution jobs.

In Example 20, the subject matter of Example 19 includes the operations further comprising configuring at least one additional execution job based on the total number of completed execution jobs and at least one additional execution job including a remaining subset of the plurality of batches.

Example 21 is a computer-storage medium comprising instructions that, when executed by one or more processors of a machine, configure the machine to perform operations comprising retrieving a database table of a database system, the database table comprising a plurality of partitions, generating a plurality of batches for the database table based on a file selection task of the database system, each batch of the plurality of batches comprising a partition subset of the plurality of partitions; configuring a plurality of execution jobs based on an execution management task of the database system, each execution job of the plurality of execution jobs including a batch subset of the plurality of batches, and skew of batch sizes for the batch subset is below a threshold skew; and performing concurrent execution of the plurality of execution jobs to cluster the partition subset associated with each of the plurality of execution jobs.

In Example 22, the subject matter of Example 21 includes the operations further comprising generating a plurality of clustered partition subsets based on the completion of clustering of the partition subset for each of the plurality of execution jobs.

In Example 23, the subject matter of Example 22 includes the operations further comprising activating a clustering lock on the plurality of clustered partition subsets and the clustering lock configured in a transactional queue for committing clustered data to the database table.

In Example 24, the subject matter of Example 23 includes the operations further comprising activating the clustering lock based on a number of data manipulation language (DML) locks placed on the database table by transactions in the transactional queue.

In Example 25, the subject matter of Example 24 includes the operations further comprising activating the clustering lock further based on a number of execution jobs in the plurality of execution jobs being higher than a maximum number of DML locks that can be placed on the database table.

In Example 26, the subject matter of Example 25 includes the operations further comprising releasing the clustering lock when the number of DML locks is below a threshold number.

In Example 27, the subject matter of Examples 24-26 includes functionalities where at least one of the transactions in the transactional queue is a user DML query placing a DML lock of the DML locks on the database table.

In Example 28, the subject matter of Examples 21-27 includes the operations further comprising selecting a number of execution jobs in the plurality of execution jobs based on a maximum number of data manipulation language (DML) locks that can be placed on the database table.

In Example 29, the subject matter of Examples 21-28 includes the operations further comprising performing a successor check at the completion of each execution job of the plurality of execution jobs to determine the total number of completed execution jobs of the plurality of execution jobs.

In Example 30, the subject matter of Example 29 includes the operations further comprising configuring at least one additional execution job based on the total number of completed execution jobs and at least one additional execution job including a remaining subset of the plurality of batches.

Example 31 is at least one machine-readable medium, including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not explicitly described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

1. A method comprising:
retrieving, by at least one hardware processor in a database system, a database table, the database table comprising a plurality of partitions;
generating a plurality of batches for the database table based on a file selection task of the database system, each batch of the plurality of batches comprising a partition subset of the plurality of partitions;
determining a skew of batch sizes for a batch subset of the plurality of batches based on a maximum difference between a size of a largest batch and a size of a smallest batch in the batch subset;
configuring a plurality of execution jobs based on an execution management task of the database system, an execution job of the plurality of execution jobs including the batch subset of the plurality of batches, the skew of batch sizes for the batch subset being below a threshold skew; and
performing concurrent execution of the plurality of execution jobs to cluster the partition subset associated with each of the plurality of execution jobs.

2. The method of claim 1, further comprising:
generating a plurality of clustered partition subsets based on completion of clustering of the partition subset for each of the plurality of execution jobs.

3. The method of claim 2, further comprising:
activating a clustering lock on the plurality of clustered partition subsets, the clustering lock configured in a transactional queue for committing clustered data to the database table.

4. The method of claim 3, further comprising:
activating the clustering lock based on a number of data manipulation language (DML) locks placed on the database table by transactions in the transactional queue.

5. The method of claim 4, further comprising:
activating the clustering lock further based on a number of execution jobs in the plurality of execution jobs being higher than a maximum number of DML locks that can be placed on the database table.

6. The method of claim 5, further comprising:
releasing the clustering lock when the number of DML locks is below a threshold number.

7. The method of claim 4, wherein at least one of the transactions in the transactional queue is a user DML query placing a DML lock of the DML locks on the database table.

8. The method of claim 1, further comprising:
selecting a number of execution jobs in the plurality of execution jobs based on a maximum number of data manipulation language (DML) locks that can be placed on the database table.

9. The method of claim 1, further comprising:
performing a successor check at completion of each execution job of the plurality of execution jobs to determine a total number of completed execution jobs of the plurality of execution jobs.

10. The method of claim 9, further comprising:
configuring at least one additional execution job based on the total number of completed execution jobs, the at least one additional execution job including a remaining subset of the plurality of batches.

11. A system comprising:
at least one hardware processor; and
at least one memory storing instructions that cause the at least one hardware processor to perform operations comprising:
retrieving a database table of a database system, the database table comprising a plurality of partitions;
generating a plurality of batches for the database table based on a file selection task of the database system, each batch of the plurality of batches comprising a partition subset of the plurality of partitions;
determining a skew of batch sizes for a batch subset of the plurality of batches based on a maximum difference between a size of a largest batch and a size of a smallest batch in the batch subset;
configuring a plurality of execution jobs based on an execution management task of the database system, an execution job of the plurality of execution jobs including a batch subset of the plurality of batches, the skew of batch sizes for the batch subset being below a threshold skew; and
performing concurrent execution of the plurality of execution jobs to cluster the partition subset associated with each of the plurality of execution jobs.

12. The system of claim 11, the operations further comprising:
generating a plurality of clustered partition subsets based on completion of clustering of the partition subset for each of the plurality of execution jobs.

13. The system of claim 12, the operations further comprising:
activating a clustering lock on the plurality of clustered partition subsets, the clustering lock configured in a transactional queue for committing clustered data to the database table.

14. The system of claim 13, the operations further comprising:
activating the clustering lock based on a number of data manipulation language (DML) locks placed on the database table by transactions in the transactional queue.

15. The system of claim 14, the operations further comprising:
activating the clustering lock further based on a number of execution jobs in the plurality of execution jobs being higher than a maximum number of DML locks that can be placed on the database table.

16. The system of claim 15, the operations further comprising:
releasing the clustering lock when the number of DML locks is below a threshold number.

17. The system of claim 14, wherein at least one of the transactions in the transactional queue is a user DML query placing a DML lock of the DML locks on the database table.

18. The system of claim 11, the operations further comprising:
selecting a number of execution jobs in the plurality of execution jobs based on a maximum number of data manipulation language (DML) locks that can be placed on the database table.

19. The system of claim 11, the operations further comprising:
performing a successor check at completion of each execution job of the plurality of execution jobs to determine a total number of completed execution jobs of the plurality of execution jobs.

20. The system of claim 19, the operations further comprising:
configuring at least one additional execution job based on the total number of completed execution jobs, the at least one additional execution job including a remaining subset of the plurality of batches.

21. A computer-storage medium comprising instructions that, when executed by one or more processors of a machine, configure the machine to perform operations comprising:
retrieving a database table of a database system, the database table comprising a plurality of partitions;
generating a plurality of batches for the database table based on a file selection task of the database system, each batch of the plurality of batches comprising a partition subset of the plurality of partitions;
determining a skew of batch sizes for a batch subset of the plurality of batches based on a maximum difference between a size of a largest batch and a size of a smallest batch in the batch subset;
configuring a plurality of execution jobs based on an execution management task of the database system, an execution job of the plurality of execution jobs including a batch subset of the plurality of batches, the skew of batch sizes for the batch subset being below a threshold skew; and
performing concurrent execution of the plurality of execution jobs to cluster the partition subset associated with each of the plurality of execution jobs.

22. The computer-storage medium of claim 21, the operations further comprising:
generating a plurality of clustered partition subsets based on completion of clustering of the partition subset for each of the plurality of execution jobs.

23. The computer-storage medium of claim 22, the operations further comprising:
activating a clustering lock on the plurality of clustered partition subsets, the clustering lock configured in a transactional queue for committing clustered data to the database table.

24. The computer-storage medium of claim 23, the operations further comprising:
activating the clustering lock based on a number of data manipulation language (DML) locks placed on the database table by transactions in the transactional queue.

25. The computer-storage medium of claim 24, the operations further comprising:
activating the clustering lock further based on a number of execution jobs in the plurality of execution jobs being higher than a maximum number of DML locks that can be placed on the database table.

26. The computer-storage medium of claim 25, the operations further comprising:
releasing the clustering lock when the number of DML locks is below a threshold number.

27. The computer-storage medium of claim 24, wherein at least one of the transactions in the transactional queue is a user DML query placing a DML lock of the DML locks on the database table.

28. The computer-storage medium of claim 21, the operations further comprising:
selecting a number of execution jobs in the plurality of execution jobs based on a maximum number of data manipulation language (DML) locks that can be placed on the database table.

29. The computer-storage medium of claim 21, the operations further comprising:
performing a successor check at completion of each execution job of the plurality of execution jobs to determine a total number of completed execution jobs of the plurality of execution jobs.

30. The computer-storage medium of claim 29, the operations further comprising:
configuring at least one additional execution job based on the total number of completed execution jobs, the at least one additional execution job including a remaining subset of the plurality of batches.
